(19) United States
(12) Patent Application Publication
(10) Pub. No.: US 2014/0363168 A1
(43) Pub. Date: Dec. 11, 2014

(54) USE OF VISIBLE CONNECTION BETWEEN DEVICES TO REPRESENT CONNECTIONS AND INTERACTIONS BETWEEN THE DEVICES

(71) Applicant: Google Inc., Mountain View, CA (US)

(72) Inventor: Jeremy Walker, San Jose, CA (US)

(21) Appl. No.: 13/659,493

(22) Filed: Oct. 24, 2012

(51) Int. Cl. H04B 10/10

(52) U.S. Cl. 398/115

(57) ABSTRACT

A method and apparatus for conveying using a visual representation extending between an electronic device and a target device, information relating to a wireless connection established between the electronic device and a target device. The visual representation may be setup and/or configured based on a determination of the location and/or position of the target device relative to the electronic device. The visual representation may comprise a visual light or laser beam, which may be emitted by a light or laser source in the electronic device, and may be projected at the target device. The conveying of information may comprise color adjustment of the visual representation based on information being conveyed. The conveyed information may relate to the status of the wireless connection and/or the transfer of data over the wireless connection. The electronic device may comprise a handheld mobile communication device, such as, for example, a smartphone or a tablet.

### TECHNICAL FIELD

Aspects of the present application relate to electronic devices. More specifically, certain implementations of the present disclosure relate to visible connection between devices to represent connections and interactions between the devices.

### BACKGROUND

Various types of electronic devices are commonly used nowadays. In this regard, electronic devices are utilized by one or more users, for various purposes, both business and personal. Examples of such devices include personal computers, laptops, cellular phones, smartphones, tablets and the like. In this regard, some electronic devices may be hand-held and/or mobile; may support communication (wired and/or wireless); and may be general or special purpose devices. Because such mobile electronic devices may often be used on the move, data and/or information may be generated and/or updated during such use.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for visible connection between devices to represent connections and interactions between the devices, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating an electronic device that may utilize visual representation to convey information relating to connections with other electronic devices.

FIG. 2 is a block diagram illustrating an electronic device that may utilize visual representation, which conveys information relating to connections with other devices, to visually interact with other objects.

FIG. 3 is a block diagram illustrating an electronic device that supports use of visual representation in conveying connectivity related information.

FIG. 4 is a flow chart that illustrates a process for using visual representation in conveying information relating to connections with other electronic devices.

### DETAILED DESCRIPTION

The present disclosure relates to a method and system for visible connection between devices to represent connections and interactions between the devices. In various implementations, an electronic device may support conveying via an external connectivity visual representation extending between the electronic device and a target device, information relating to a wireless connectivity between the electronic device and the target device. The external connectivity visual representation may comprise any means for conveying information in a manner that may be visually perceived by user(s). The connectivity visual representation may comprise a light or laser beam. For example, when the wireless connection is established between the electronic device and a target device, location of the target device relative to the electronic device may be determined, and the connectivity visual representation may then be configured based on the determined location of the target device, such as by controlling directionality of the connectivity visual representation to projects at the target device. The location of the target device relative to the electronic device may be determined based on determination of location of each of the electronic device and the target device.

The conveyed information may comprise information pertaining to status of the wireless connection and/or communication (e.g., active transfer) of data over the wireless connection. Conveying the information may be based on setting and/or adjusting of color in the connectivity visual representation. The electronic device may interact with the target device via the connectivity visual representation. The interacting may be achieved by adjusting characteristics of the connectivity visual representation, such as by modifying projection position of the connectivity visual representation (e.g., light or laser beam).

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “exemplary” means serving as a non-limiting example, instance, or illustration. As utilized herein, the term “e.g.,” introduces a list of one or more non-limiting examples, instances, or illustrations.

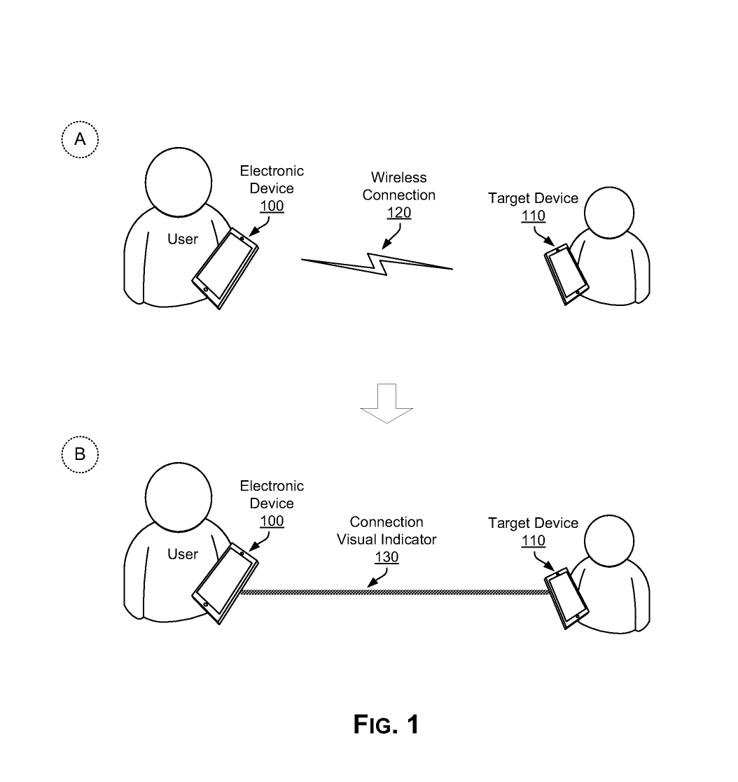

FIG. 1 is a block diagram illustrating an electronic device that may utilize visual representation to convey information relating to connections with other electronic devices. Referring to FIG. 1, there is shown an electronic device 100 and a target device 110.

The electronic device 100 may comprise suitable circuitry, interfaces, logic, and/or code that may be operable to perform various functions or operations, and/or run various applications and/or programs. In this regard, operations, functions, applications and/or programs supported by the electronic device 100 may be performed, executed and/or run based on user instructions and/or pre-configured instructions. The electronic device 100 may support communication of data, such as via wired and/or wireless connections, in accordance with one or more supported wireless and/or wired protocols or standards. In some instances, the electronic device 100 may be a handheld mobile device—i.e., be intended for use on the move and/or at different locations. In this regard, the electronic device 100 may be designed and/or configured to allow for ease of movement, such as to allow it to be readily moved while being held by the user as the user moves, and the electronic device 100 may be configured to perform at least some of the functions, applications or operations supported by device on the move. Examples of such electronic devices may comprise handheld mobile devices, such as cellular phones (e.g., smartphones) and tablets, laptop computers, and/or other similar devices. The disclosure, however, is not limited to any particular type of electronic devices.

The target device 110 may comprise suitable circuitry, interfaces, logic, and/or code operable to allow for establishment of connections with the electronic device 100, and/or exchange of data therewith using established connections. In this regard, the target device 110 may also comprise a mobile handheld communication device, such as a smartphone or a tablet. In other words, the target device 110 may also be an electronic device similar to the electronic device 100. The disclosure, however, is not limited to any particular type of target devices.

In operation, the electronic device 100 may establish connections with other devices, such as the target device 100, to enable exchanging of data therebetween for example. In this regard, connectivity between the electronic device 100 and the target device 110 may be established using wireless connections, such as wireless connection 120 for example. The wireless connection 120 may comprise a short range wireless connection, configured, for example, in accordance with a protocol or interface that is suited for exchanging data at sufficient rates, and at sufficient ranges. For example, the wireless connection 120 may comprise a Bluetooth, ZigBee, or NFC based connection. Once the wireless connection 120 is established, data may be exchanged between the electronic device 100 and the target device 110 using the wireless connection 120.

Because wireless connectivity does not entail use of physical, perceivable connections between the peers, it may be hard to determine when wireless connections are established, and/or when data is being exchanged over them. Accordingly, in various implementations of the disclosure, visual representations may be utilized to convey information relating to wireless connectivity. The information relating to wireless connectivity may comprise, for example, information pertaining presence or establishment (or not) of connectivity between the devices and/or use of any connections in transferring or exchanging data. But the disclosure is not so limited, and any information pertinent to wireless connectivity may be conveyed by such representations. For example, the electronic device 100 and/or the target device 110 may be configured to setup and/or utilize a connection visual indicator 130, to convey information relating to wireless connectivity between the devices, such as indicating when wireless connections (e.g., wireless connection 120) are established, and/or when data is actively being exchanged or transferred over the wireless connection(s). In this regard, visual representations, such as the connection visual indicator 130, may comprise any means for conveying information relating to connectivity in a manner that may be visually perceived by user(s).

The connection visual indicator 130 may comprise, for example, a light or a laser beam, which may be configured to, for example, extend from one device (e.g., the electronic device 100) to another device (target device 110). In this regard, the light or laser beam may be configured to project from the electronic device 100 towards the target device 110. For example, the electronic device 100 may comprise a light or laser source that may be configured to emit a light or laser beam in a particular direction. Thus, once the wireless connection 120 is established between the electronic device 100 and the target device 110 (as shown in A), the location of the target device 110, relative to the electronic device 100 may be determined. In this regard, the relative location of the target device 110 may be determined in various ways. For example, in instances where each of the electronic device 100 and the target device 110 are configured to obtain their (absolute) location, such as by use of GPS or other similar navigation systems, the devices may exchange their location information (e.g., via connection 120 or any other connection available between the devices), which may then be used in determining the location and/or position of the target device 110 relative to the electronic device 100. Alternatively, the electronic device 100 may be configured to autonomously determine the relative location of the target device 110, such as by use of ranging techniques.

Once the relative location of the target device 110 is determined, the electronic device 100 may use that information in configuring the light or laser beam such that it may be directed at the target device 110 (as shown in B). Thus, the connection visual indicator 130 may be generated and/or configured (e.g., directed to point at the target device 110) to indicate the presence of wireless connection 120 between the electronic device 100 and the target device 110. In some instances, the connection visual indicator 130 may convey additional information, beside simply the existence (or establishment) of connection. The connection visual indicator 130 may also be utilized to indicate, for example, when data is being transferred and/or exchanged. In other words, the connection visual indicator 130 may be used to convey to users information about connections (if any) between devices used by the users. It is understood that the information conveyed via the connection visual indicator 130 is different and distinct from any data transfers between the devices, using any connection available therebetween. Information may be conveyed, for example, via the connection visual indicator 130 based on color adjustments. In this regard, particular colors (or hues) may be used to indicate particular information. In instances where the connection visual indicator 130 comprises a light beam, for example, the color of the light beam may be utilized to convey information relating to the wireless connection 120. For example, once the wireless connection 120 is established (A), a light beam may be configured and projected (B) at the target device 110, and the light beam may be configured to have a red color (i.e., a red light or laser beam). When data is actually being transferred or exchanged, the color of the light beam may be adjusted, such as from red to green (i.e., as green light or laser beam). Then, when data transferred or exchange is complete or ceased, the color of the light beam may be readjusted, as back to red (i.e., as red light or laser beam).

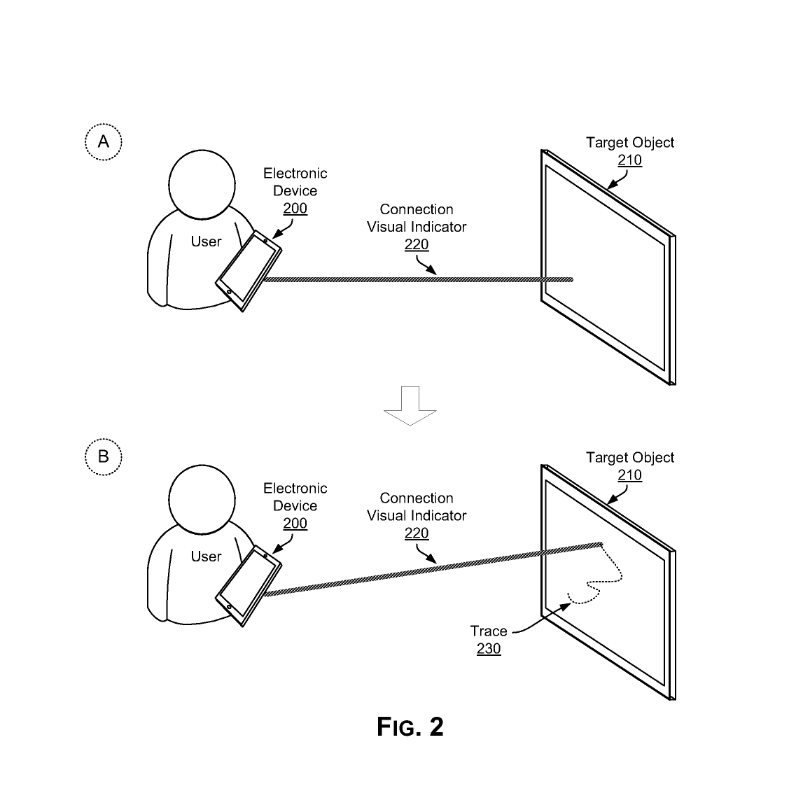

FIG. 2 is a block diagram illustrating an electronic device that may utilize visual representation, which conveys information relating to connections with other devices, to visually interact with other objects. Referring to FIG. 2, there is shown an electronic device 200 and a target object 210.

The electronic device 200 may substantially similar to the electronic device 100, as described with respect to FIG. 1, for example. The target object 210 may comprise suitable circuitry, interfaces, logic, and/or code that may be operable to communicate, including wirelessly, with the electronic device 200. The target object 210 may be configured to support use of visual representations in conveying information pertaining to wireless connectivity, substantially as described with respect to FIG. 1 (e.g., with regard to the target device 110). The target object 210 may comprise a fixed object, such as a large flat display or a smart wall.

In operation, the electronic device 200 and/or the target object 210 may be configured to setup and/or utilize a connection visual indicator 220, to convey information relating to wireless connectivity between the devices, such as indicating when wireless connections (not shown) are established between the electronic device 200 and the target object 210, and/or when data is actively being exchanged or transferred over the wireless connection(s), substantially as described with respect to FIG. 1. In this regard, the connection visual indicator 220 may comprise any means for conveying information relating to connectivity in a manner that may be visually perceived by user(s). The connection visual indicator 220 may comprise, again, a light or laser beam, which may be configured to project from the electronic device 200 towards (i.e., directed to point at) the target object 210. In this regard, the light or laser beam may be configured to project from the electronic device 200 towards the target object 210. In this regard, once wireless connectivity is established between the electronic device 200 and the target object 210, and location of the target object 210 relative to the electronic device 200 is determined, the electronic device 200 may configure the light or laser beam such that it may be directed at the target object 210 (as shown in A). Thus, the connection visual indicator 220 may be generated and/or configured (e.g., directed to point at the target object 210) to indicate the presence of wireless connectivity between the electronic device 200 and the target object 210. Furthermore, the connection visual indicator 220 may also convey additional information, beside simply the existence (or establishment) of wireless connectivity, such as active transfer and/or exchange of data. In this regard, the connection visual indicator 220 may also be configured to utilize such means as color adjustments to convey different information pertaining to wireless connectivity, as described with respect to FIG. 1.

In some instances, the target object 210 may be operable to support interactions by the electronic device 200, such as the use of visual representation (e.g., the connection visual indicator 220) in conveying information relating to wireless connectivity between the electronic device 200 and the target object 210. For example, in instances where the connection visual indicator 220 comprises a light or laser beam, user of the electronic device 200 may use the beam to interact with the target object 210, such as by pointing and/or moving the electronic device 200 in a manner that controls and/or alters the projection point of the beam on the target object 210, to create a trace 230 resulting from the movement of the beam projection point for example. The target object 230 may be configured to track the trace 230, and/or to interpret it appropriately, such that to derive particular user input or feedback based on that trace. For example, the trace 230 may be used to input particular commands, select particular options and/or settings that may be displayed by the target object 210. Thus, use of electronic device 200 to create the trace 230, by adjusting directionality of the connection visual indicator 220, may allow the device user to submit particular requests (e.g., playing particular content), enter particular commands (e.g., start, stop, pause, fast-forward, or rewind when viewing content), and/or to adjust settings and/or options in the target object 230 (e.g., adjust audio and/or video related settings when viewing content).

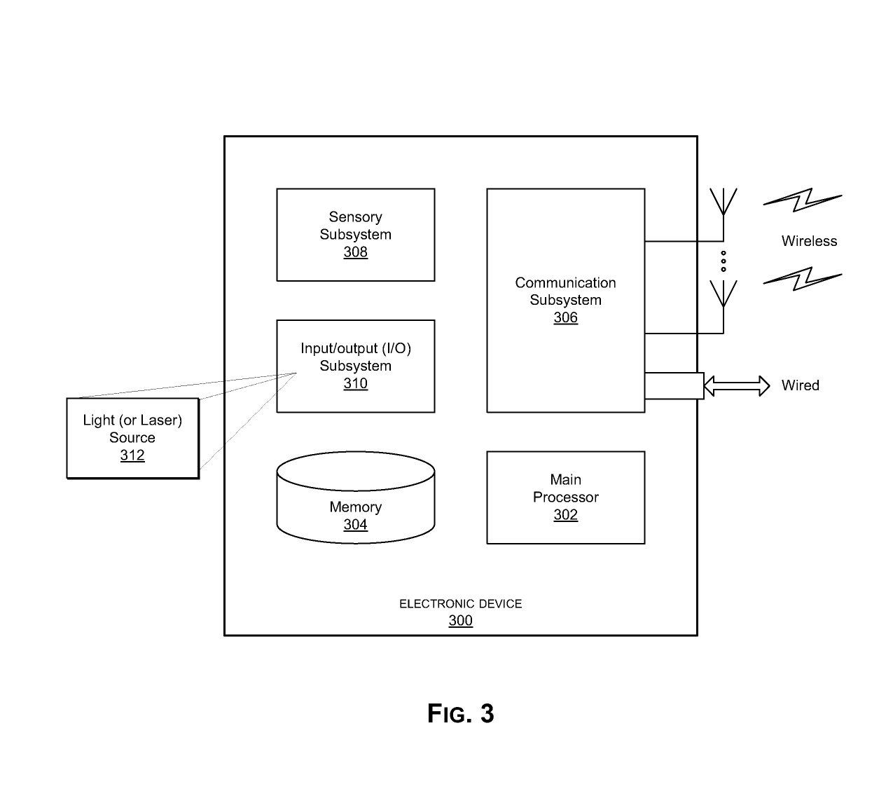

FIG. 3 is a block diagram illustrating an electronic device that supports use of visual representation in conveying connectivity related information. Referring to FIG. 3, there is shown an electronic device 300.

The electronic device 300 may comprise suitable circuitry, interfaces, logic, and/or code that may be operable to implement various aspects of the disclosure. In this regard, the electronic device 300 may correspond to the electronic devices 100 and 200 of FIGS. 1 and 2, respectively, for example. The electronic device 300 may comprise, for example, a main processor 302, a system memory 304, a communication subsystem 306, a sensory subsystem 308, and an input/output (I/O) subsystem 310.

The main processor 302 may comprise suitable circuitry, interfaces, logic, and/or code that may be operable to process data, and/or control and/or manage operations of the electronic device 300, and/or tasks and/or applications performed therein. In this regard, the main processor 302 may configure and/or control operations of various components and/or subsystems of the electronic device 300, by utilizing, for example, one or more control signals. The main processor 302 may enable running and/or execution of applications, programs and/or code, which may be stored, for example, in the system memory 304. Alternatively, one or more dedicated application processors may be utilized for running and/or executing applications (or programs) in the electronic device 300. In some instances, some of the applications running and/or executing on the electronic device 300 may generate and/or update video content that may be rendered via the display 230.

The system memory 304 may comprise suitable circuitry, interfaces, logic, and/or code that may enable permanent and/or non-permanent storage, buffering, and/or fetching of data, code and/or other information, which may be used, consumed, and/or processed. In this regard, the system memory 304 may comprise different memory technologies, including, for example, read-only memory (ROM), random access memory (RAM), Flash memory, solid-state drive (SSD), and/or field-programmable gate array (FPGA). The system memory 304 may store, for example, configuration data, which may comprise parameters and/or code, comprising software and/or firmware.

The communication subsystem 306 may comprise suitable circuitry, interfaces, logic, and/or code operable to communicate data from and/or to the electronic device, such as via one or more wired and/or wireless connections. The communication subsystem 306 may be configured to support one or more wired protocols (e.g. Ethernet standards) and/or wireless protocols or interfaces (e.g., Bluetooth, WiFi, cellular, WiMAX, and/or any available wireless protocol/interface), facilitating transmission and/or reception of signals to and/or from the electronic device 300, and/or processing of transmitted or received signals in accordance with applicable wired or wireless protocols. In this regard, signal processing operations may comprise, for example, filtering, amplification, analog-to-digital conversion and/or digital-to-analog conversion, up-conversion/down-conversion of baseband signals, encoding/decoding, encryption/ decryption, and/or modulation/demodulation.

The sensory subsystem 308 may comprise suitable circuitry, interfaces, logic, and/or code for obtaining and/or generating sensory information, which may relate to the electronic device 300, its user(s), and/or its environment. For example, the sensory subsystem 308 may comprise positional or locational sensors (e.g., GPS or other GNSS based sensors), ambient conditions (e.g., temperature, humidity, or light) sensors, and/or motion related sensors (e.g., accelerometer, gyroscope, pedometers, and/or altimeters).

The I/O subsystem 310 may comprise suitable circuitry, interfaces, logic, and/or code for enabling and/or managing user interactions with the electronic device 300, such as obtaining input from, and/or to providing output to, the device user(s). The I/O subsystem 310 may support various types of inputs and/or outputs, including, for example, video, audio, and/or textual. In this regard, dedicated I/O devices and/or components, external to or integrated within the electronic device 300, may be utilized for inputting and/or outputting data during operations of the I/O subsystem 310. Examples of such dedicated I/O devices may comprise displays, mice, keyboards, touch screens (or pads), and the like.

The I/O subsystem 310 may comprise a light or laser source 312, which may comprise suitable circuitry, interfaces, logic, and/or code for generating and/or emitting light or laser beams. In this regard, the light or laser source 312 may be configured to generate or emit narrow light or laser beams, in directional manner—i.e., such that it may be pointed at a particular point in space around the electronic device 300. In some instances, a color of the light or laser beams may be adjusted, such as to enable conveying different information pertaining to connectivity, as described with respect to FIGS. 1 and 2. In this regard, modifying the color of generated or emitted light or laser beams may be achieved by use of a configurable filter that allows only light or laser waves corresponding to particular color(s) to pass through. Alternatively, the light or laser source 312 may be configured to generate the light or laser beams with particular colors. In some instances, the light or laser source 312 may be configured to allow modifying directionality on the fly. This may be achieved by implementing the light or laser source 312 as a movable component, with 3-dimensional adjusters to enable adjusting the directionality of generated or emitted light or laser beams dynamically and/or adaptively. Such directionality adjustment may be used in instances where light or laser beams are utilized, in addition to conveying connectivity related information, in interacting with the target device or object, as described with respect to FIG. 2 for example.

In operation, the electronic device 300 may be utilized to setup and/or utilize visual connection representations to convey information relating to wireless connectivity, substantially as described with respect electronic devices 100 and 200 of FIGS. 1 and 2, respectively. In this regard, the electronic device 300 may be configured to utilize light or laser beams, which may be generated and/or emitted via the light or laser source 312, as visual connection representations. For example, once the electronic device 300 establishes a wireless connection with a target device or object (e.g., target device 110 of FIG. 1 and target object 210 of FIG. 2), location of the target device or object relative to the electronic device 300 may be determined, such as by using ranging means in the electronic device 300 or based on absolute location information corresponding to each of the electronic device 300, which may be obtained based on GPS (or similar) system(s). Once the relative location of the target device or object is determined, the electronic device 300 may use that information in configuring the light or laser beam such that it may be directed at the target device or object. This may be achieved by configuring the light or laser source 312 to generate and/or emit the light or laser beam directionality to project from the electronic device 300 towards (i.e., directed to point at) the target device or object.

In some implementations, the light or laser beam emitted by the light or laser source 312 may also convey additional information, besides simply the existence (or establishment) of wireless connectivity, such as indication of active transfer and/or exchange of data. For example, a color of the light or laser beam may be adjusted, via the light or laser source 312, to convey different information pertaining to wireless connectivity, as described with respect to FIGS. 1 and 2 for example. Furthermore, in some instances, the light or laser beam emitted by the electronic device 300 may be utilized to facilitate interactions by the electronic device 300 with the target device or object. For example, the directionality of the emitted light or laser beam may be adjusted, such as based on movement of the electronic device 300 as a whole (e.g., being used a ‘pointer’ by the device user) and/or based on movement of (only) the light or laser source 312, based on user commands or input for example. The adjustment in directionality of the light or laser beam may result in altering the projection point of the beam on the target device or object, which may be done in a manner that may enable the target device or object to interpret the changes in projection point to derive particular user input or feedback, as described with respect to FIG. 2 for example.

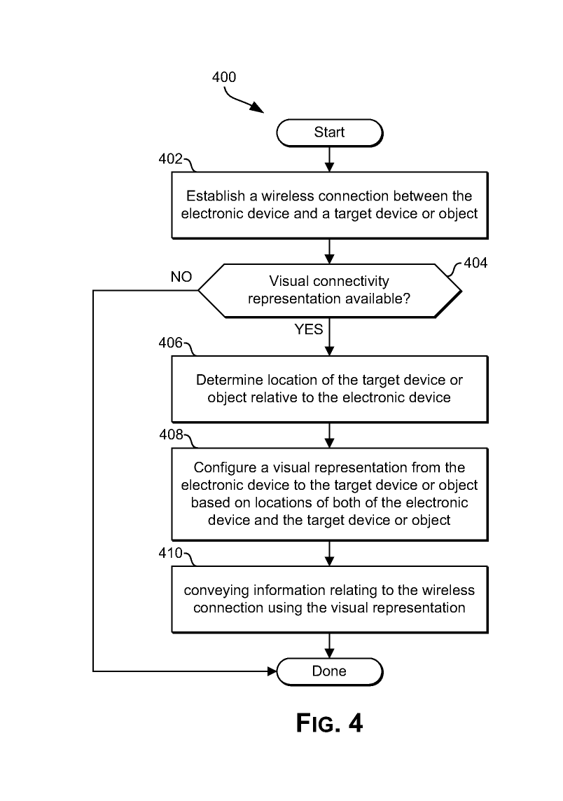

FIG. 4 is a flow chart that illustrates a process for using visual representation in conveying information relating to connections with other electronic devices. Referring to FIG. 4, there is shown a flow chart 400 comprising a plurality of exemplary steps for utilizing, via an electronic device (e.g., device 300) visual representation in conveying information relating to connections and/or use thereof, between devices or objects.

In step 402, a connection (e.g., wireless) may be established between the electronic device (e.g., device 300) and a target device (or object), such as the target device 110 or target object 210. In step 404, a determination may be performed regarding whether use of visual representation in conjunction with connectivity between the electronic device and the target device (or object) is available. In this regard, the availability of use of visual representation may depend on, for example, availability of visual means generation (e.g., light source) in either side, availability of means for conveying information via any available visual means (e.g., applying different colors), ability to configure the visual means in the direction of the other device (or object). In instances where it may be determined that use of visual connectivity representation is not available, the process may terminate.

Returning to step 404, in instances where it may be determined that that use of visual connectivity representation is available, the process may proceed to step 406. In step 406, location of the target device (or object), relative to the electronic device, may be determined. In this regard, various methods may be utilized in determining the target device (or object) relative location. For example, the absolute positions of both the electronic device and the target device (or object) may be determined autonomously, such as by use of GPS or other GNSS components or systems in each of these devices for example, and differences between the two absolute positions (e.g., by comparing or subtracting the absolute positions, after that information is exchanged between the devices) may then be used in determining the relative location of the target device (or object). Alternatively, ranging mechanisms (e.g., using reflection of laser beams) may be used in determining the relative location. In step 408, a visual representation may be setup and/or configured, extending from the electronic device to the target device (or object) based on locations of both of the electronic device and the target device (or object). In step 410, information relating to the wireless connection(s) may be conveyed using the visual representation. For example, the conveyed information may comprise information pertaining to status of the wireless connection and/or transfer of data over the wireless connection.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for visible connection between devices to represent connections and interactions between the devices.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

1. A method in an electronic device, comprising:
establishing a wireless connection between the electronic device and a target device;
determining a location of the electronic device based on a GPS location of the electronic device;
determining a location of the target device relative to the location of the electronic device;
configuring a visible light beam, separate from the wireless connection, based on the determined location of the target device, wherein the configuring comprises controlling directionality of the visible light beam, which comprises a narrow and directional light beam, such that the visible light beam projects from the electronic device towards the target device, wherein the visible light beam comprises a first color indicating that the wireless connection for transferring data, the wireless connection being separate from the visible light beam, is established between the electronic device and the target device;
conveying, via the visible light beam, information relating to the wireless connection or information relating to communication of data over the wireless connection; and
transferring data between the electronic device and the target device using the wireless connection, wherein a color of the visible light beam is adjusted from the first color to a second color indicating that data is currently being transferred between the electronic device and the target device using the wireless connection that is separate from the visible light beam;
wherein the directionality of the visible light beam is adjusted based on movement of the electronic device.

2. The method of claim 1, wherein the color of the visible light beam is adjusted from the second color to the first color after data transfer between the electronic device and the target device using the wireless connection is complete or ceased.

3. (canceled)

4. The method of claim 1, comprising determining the location of the target device relative to the electronic device based on determination of location of each of the electronic device and the target device.

5. The method of claim 1, comprising interacting with the target device via the visible light beam.

6. The method of claim 5, comprising interacting with the target device via the visible light beam by adjusting characteristics of the visible light beam.

7. The method of claim 6, wherein adjusting characteristics of the visible light beam comprises modifying projection position of the visible light beam on the target device.

8. A method in an electronic device, comprising:
establishing a wireless connection between the electronic device and a target device;
configuring an external visual representation, which comprises a narrow and directional light beam, such that the external visual representation projects from the electronic device towards the target device, wherein the external visual representation comprises a first color indicating that the wireless connection for transferring data, the wireless connection being separate from the external visual representation, is established between the electronic device and the target device;
conveying, via the external visual representation extending between the electronic device and a target device, information relating to the wireless connection established between the electronic device and the target device; and
transferring data between the electronic device and the target device using the wireless connection, wherein a color of the external visual representation is adjusted from the first color to a second color indicating that data is currently being transferred between the electronic device and the target device using the wireless connection, wherein the external visual representation is separate from the wireless connection, and wherein the directionality of the visible light beam is adjusted based on movement of the electronic device.

9. The method of claim 8, wherein the color of the external visual representation is adjusted from the second color to the first color after data transfer between the electronic device and the target device using the wireless connection is complete or ceased.

10. (canceled)

11. The method of claim 8, wherein the visual representation comprises a visible light beam or a laser beam.

12. The method of claim 8, comprising interacting with the target device via the visual representation.

13. The method of claim 12, comprising interacting with the target device via the visual representation by adjusting characteristics or parameters associated with the visual representation.

14. An electronic device, comprising:
at least one light emitter;
at least one wireless front-end module;
at least one processor; and
a memory containing executable instructions that when executed by the at least one processor cause the electronic device to perform a method for controlling display functions in the electronic device, the method comprising:
establishing via the at least one wireless front-end module, a wireless connection between the electronic device and a target device;
determining a location of the electronic device based on a GPS location of the electronic device;
determining a location of the target device relative to the location of the electronic device;
configuring the at least one light emitter to emit a visible light beam based on the determined location of the target device, wherein the configuring comprises controlling directionality of the visible light beam, which comprises a narrow and directional light beam, such that the visible light beam projects from the electronic device towards the target device,
wherein the visible light beam comprises a first color indicating that the wireless connection for transferring data, the wireless connection being separate from the visible light beam, is established between the electronic device and the target device;
conveying, via the visible light beam and separate from the wireless connection, information relating to the established wireless connection or information relating to communication of data over the wireless connection; and
causing the at least one wireless front-end module to transfer data between the electronic device and the target device using the wireless connection, wherein a color of the visible light beam is adjusted from the first color to a second color indicating that data is currently being transferred between the electronic device and the target device using the wireless connection that is separate from the visible light beam;
wherein the directionality of the visible light beam is adjusted based on movement of the electronic device.

15. The electronic device of claim 14, wherein the color of the visible light beam is adjusted from the second color to the first color after data transfer between the electronic device and the target device using the wireless connection is complete or ceased.

16. (canceled)

17. The electronic device of claim 14, wherein the method comprises determining the location of the target device relative to the electronic device based on a determination of location of each of the electronic device and the target device.

18. The electronic device of claim 14, wherein the method comprises interacting with the target device via the visible light beam.

19. The electronic device of claim 18, wherein interacting with the target device via the visible light beam comprises adjusting characteristics of the visible light beam.

20. The electronic device of claim 19, wherein adjusting characteristics of the visible light beam comprises modifying projection position of the visible light beam on the target device.

21. A system, comprising:
a target device; and
an electronic device configured to:
control directionality of an external visual representation, which comprises a narrow and directional light beam, such that the external visual representation projects from the electronic device towards the target device, wherein the external visual representation comprises a first color indicating that a wireless connection for transferring data, the wireless connection being separate from the external visual representation, is established between the electronic device and the target device;
convey, via the external visual representation extending between the electronic device and a target device, information relating to a wireless connection established between the electronic device and the target device; and
transfer data between the electronic device and the target device using the wireless connection established between the electronic device and the target device, wherein the color of the external visual representation is adjusted from the first color to a second color indicating that data is currently being transferred between the electronic device and the target device using the wireless connection, wherein the external visual representation is separate from the wireless connection, and wherein the directionality of the visible light beam is adjusted based on movement of the electronic device.

22. The system of claim 21, wherein the color of the external visual representation is adjusted from the second color to the first color after data transfer between the electronic device and the target device using the wireless connection is complete or ceased.

23. The system of claim 21, wherein the electronic device is configured to convey the information relating to the wireless connection based on color adjustment in the visual representation.

24. The system of claim 21, wherein the visual representation comprise a visible light beam or a laser beam.

25. The system of claim 21, wherein the electronic device is configured to interact with the target device via the visual representation.

26. The system of claim 25, wherein interacting with the target device via the visual representation comprises adjusting characteristics or parameters associated with the visual representation.

27. The method of claim 1, wherein the location of the target device relative to the electronic device is determined by comparing an independently determined location of the electronic device to an independently determined location of the target device.

28. The method of claim 27, wherein the electronic device and the target device each include components for determining absolute positions of the electronic device and the target device.

29. The electronic device of claim 14, wherein the location of the target device relative to the electronic device is determined by comparing an independently determined location of the electronic device to an independently determined location of the target device.

30. The electronic device of claim 29, wherein the electronic device and the target device each include components for determining absolute positions of the electronic device and the target device.

31. The method of claim 1, wherein the narrow and directional light beam comprises a laser beam.

32. The method of claim 8, wherein the narrow and directional light beam comprises a laser beam.

33. The electronic device of claim 14, wherein the narrow and directional light beam comprises a laser beam.
